(19) United States
(12) Patent Application Publication
(10) Pub. No.: US 2008/0148834 A1
(43) Pub. Date: Jun. 26, 2008

(54) Detection apparatus and engine control unit

(75) Inventor: Izuru Shinjo, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Tokyo (JP)

(21) Appl. No.: 11/653,924

(22) Filed: Jan. 17, 2007

(30) Foreign Application Priority Data
Oct. 4, 2006 (JP) 2006-273055

(51) Int. Cl. G01M 19/00

(52) U.S. Cl. 73/116.01

(57) ABSTRACT

A detection apparatus has an intake air temperature detection part less prone to receive an adverse influence due to hear generation in an intake air pressure detection part. The apparatus includes an exterior resin integrated with a terminal having one end exposed therefrom, a sensor module received in the exterior resin and having a lead frame connected to the other end of the terminal, an intake air pressure detection part electrically connected to the lead frame for detecting air pressure in the intake pipe, an intake air temperature detection part electrically connected to the lead frame for detecting an air temperature in the intake pipe, and a base having a base end connected to the exterior resin and a vent hole for introducing the air in the intake pipe to the intake air pressure and temperature detection parts. The intake air pressure and temperature detection parts are formed separately from each other.

### BACKGROUND OF THE INVENTION

1. Field of the Invention

The present invention relates to a detection apparatus for detecting the pressure and temperature of air in an intake pipe, and to an engine control unit using this detection apparatus.

2. Description of the Related Art

As a conventional detection apparatus, there has been known one in which an intake air pressure detection part covered with a gel and an intake air temperature detection part not covered with a gel for improved response of temperature measurements are formed by a single semiconductor chip (see, for example, a first patent document: Japanese patent No. 3772079 (FIG. 1 and FIG. 7)).

In addition, this detection apparatus has an end thereof arranged to protrude into the interior of the intake pipe so as to expose the semiconductor chip to the air that flows in the intake pipe.

In such a detection apparatus as constructed above, however, there are the following problems.

(A) Since the intake air pressure detection part and the intake air temperature detection part are formed into the single semiconductor chip, the generation of heat in the intake air pressure detection part exerts an adverse influence on the temperature measurement of the intake air temperature detection part.

(B) An end of the detection apparatus, being arranged to protrude into the intake pipe, obstructs the smooth flow of the air flowing in the intake pipe to make a stable amount of air unable to be supplied to the inside of the engine, whereby the control of the amount of fuel to be injected into the engine becomes unstable.

### SUMMARY OF THE INVENTION

The present invention is intended to obviate the problems as referred to above, and has for its object to provide a detection apparatus in which an intake air temperature detection part is less prone to receive an adverse influence due to the heat generation of an intake air pressure detection part.

Another object of the present invention is to provide a detection apparatus in which the air flowing in an intake pipe can be supplied to the inside of an engine in a stable manner.

A further object of the present invention is to provide an engine control unit in which the control of the amount of fuel to be injected into the engine can be improved.

Bearing the above objects in mind, according to a first aspect of the present invention, there is provided a detection apparatus which is installed at an air introduction opening formed in an intake pipe, the apparatus including: an exterior resin that is integrated with a terminal having one end portion thereof exposed therefrom; a sensor module that is received in the inside of the exterior resin and has a lead frame connected to the other end of the terminal; an intake air pressure detection part that is electrically connected to the lead frame for detecting the pressure of air in the intake pipe; an intake air temperature detection part that is electrically connected to the lead frame for detecting the temperature of the air in the intake pipe; and a base that has a base end connected to the exterior resin and at the same time has a vent hole for introducing the air in the intake pipe to the intake air pressure detection part and the intake air temperature detection part. The intake air pressure detection part and the intake air temperature detection part are formed separately from each other.

The detection apparatus according to the first aspect of the present invention as constructed above has an advantageous effect that the intake air temperature detection part is less prone to receive an adverse influence due to the heat generation of the intake air pressure detection part.

According to a second aspect of the present invention, there is provided a detection apparatus which is installed at an air introduction opening formed in an intake pipe, the apparatus including: an exterior resin that is integrated with a terminal having one end portion thereof exposed therefrom; a sensor module that is received in the inside of the exterior resin and has a lead frame connected to the other end of the terminal; an intake air pressure detection part that is electrically connected to the lead frame for detecting the pressure of air in the intake pipe; an intake air temperature detection part that is electrically connected to the lead frame for detecting the temperature of the air in the intake pipe; and a base that has a base end connected to the exterior resin and at the same time has a vent hole for introducing the air in the intake pipe to the intake air pressure detection part and the intake air temperature detection part. Upon insertion of the base into the air introduction opening, the base is inserted into the air introduction opening with a tip end surface of the base being positioned on an inner wall surface of the intake pipe or at a location diametrally outwardly therefrom.

The detection apparatus according to the second aspect of the present invention as constructed above has an advantageous effect that the air flowing in the intake pipe is supplied to the inside of the engine in a stable manner.

According to a third aspect of the present invention, there is provided an engine control unit which includes: an exterior resin that is integrated with a terminal having one end portion thereof exposed therefrom; a sensor module that is received in the inside of the exterior resin and has a lead frame connected to the other end of the terminal; an intake air pressure detection part that is electrically connected to the lead frame for detecting the pressure of air in an intake pipe; an intake air temperature detection part that is electrically connected to the lead frame for detecting the temperature of the air in the intake pipe; and a base that has a base end connected to the exterior resin and at the same time has a vent hole for introducing the air in the intake pipe to the intake air pressure detection part and the intake air temperature detection part. The amount of fuel injected to each cylinder of the engine including the pressure and the temperature of the air detected is controlled by using the detection apparatus in which the intake air pressure detection part and the intake air temperature detection part are formed separately from each other.

The engine control unit according to the third aspect of the present invention as constructed above has an advantageous effect that the control of the amount of fuel to be injected into the engine can be improved.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a cross sectional view showing a detection apparatus according to a first embodiment of the present invention.

FIG. 2 is a cross sectional view showing a state in which the detection apparatus of FIG. 1 is attached to an intake pipe.

FIG. 3 is a cross sectional view showing a detection apparatus according to a second embodiment of the present invention.

FIG. 4 is a block diagram showing an engine control unit to which the detection apparatus of FIG. 1 is applied.

### DESCRIPTION OF THE PREFERRED EMBODIMENTS

Now, preferred embodiments of the present invention will be described in detail while referring to the accompanying drawings. Throughout respective figures, the same or corresponding members or parts are identified by the same reference numerals and characters.

### Embodiment 1

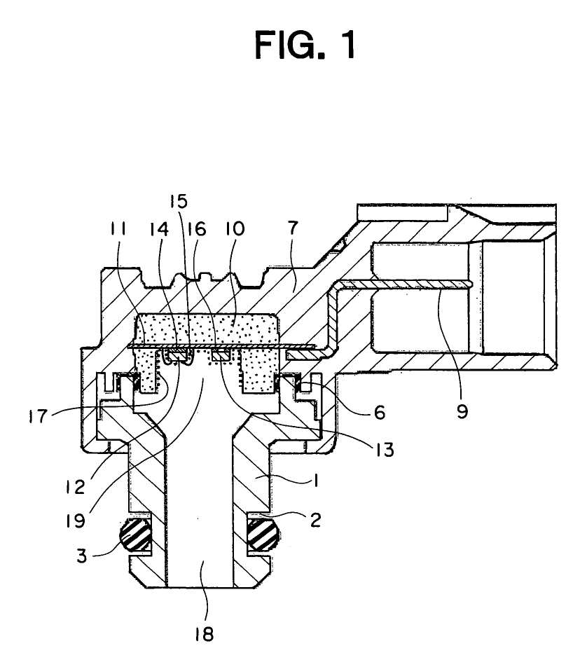

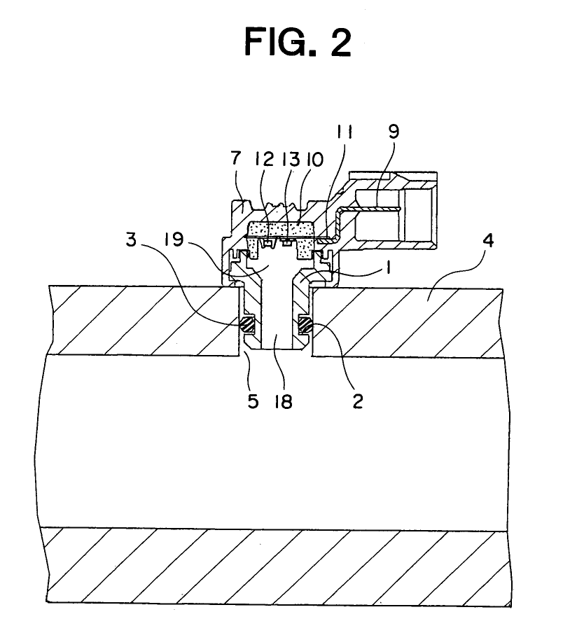

Referring to the drawings and first to FIG. 1, there is shown, in a cross sectional view, a detection apparatus according to a first embodiment of the present invention. FIG. 2 is a cross sectional view when the detection apparatus of FIG. 1 is attached to an intake pipe.

In this detection apparatus, a base 1 having a vent hole 18 is formed on its peripheral side surface with a groove 2 over the entire circumference thereof. An O ring 3 is fitted in this groove 2. An intake pipe 4, being placed in communication to an engine, has an air introduction opening 5 formed through the side wall thereof.

The base 1 of this detection apparatus is coupled at its basal end portion with an exterior resin 7 by a bonding material 6. The exterior resin 7 is integrated by insert molding with a terminal 9 that has one end thereof exposed therefrom. PPS, PBT, etc., are used as a material for the exterior resin 7.

The detection apparatus is attached to the intake pipe 4 while ensuring air tightness by means of the O ring 3 with the base 1 being inserted into the air introduction opening 5. In addition, upon insertion of the base 1 into the air introduction opening 5, the base 1 is inserted into the air introduction opening 5 with a tip end surface of the base 1 being positioned at a location diametrally outwardly of the inner wall surface of the intake pipe 4.

Here, note that the tip end surface of the base 1 may be inserted into the air introduction opening 5 while being located on the inner wall surface of the intake pipe 4.

A sensor module 10 is received in an inner space which is defined by the base 1 and the exterior resin 7 coupled thereto. This sensor module 10 has a lead frame 11 integrated therewith by means of transfer molding by the use of an epoxy resin. This lead frame 11 is electrically connected through welding with the other end of the terminal 9.

The sensor module 10 is concaved or recessed at a side thereof near the base 1 with the lead frame 11 being partially exposed from its bottom. On the exposed portion of the lead frame 11 on the same surface thereof, there are mounted an intake air pressure detection part 12 for detecting the pressure of air in the intake pipe 4 and an intake air temperature detection part 13 for detecting the temperature of air in the intake pipe 4.

The mounting of the intake air pressure detection part 12 on the lead frame 11 is carried out by the use of a silicon-based die bonding resin 14. This intake air pressure detection part 12 is electrically connected to the lead frame 11 by using a gold wire 15.

Also, the mounting of the intake air temperature detection part 13 is carried out in such a manner that the electrodes of the intake air temperature detection part 13 is fixedly secured to the lead frame 11 by using an electrically conductive epoxy resin-based paste 16. This resin paste 16 serves not only for fixed securing but also for electrical connection.

Here, note that the intake air pressure detection part 12 need not necessarily be mounted on the lead frame 11, but may instead be mounted on a region of the sensor module 10 where the lead frame 11 is not exposed therefrom, and be electrically connected to the lead frame 11 by using the gold wire 15.

For the lead frame 11, there is usually used an iron-based or copper-based material which has been subjected first to appropriate plating treatment and then to etch or press processing whereby it is processed to a predetermined configuration or shape. The lead frame 11 functions as electrical wiring that transmits electric signals from the intake air pressure detection part 12 and the intake air temperature detection part 13 to an engine control unit to be described later through the terminal 9.

The intake air pressure detection part 12 has a piezoresistor that can be strained or distorted by pressure to change its electric resistance, and an electronic circuit including transistors, capacitors, etc., for converting the resistance value of the piezoresistor that changes in accordance with the amount of distortion.

The intake air temperature detection part 13 is composed of a chip thermistor for surface mounting.

A very thin organic protective film or layer 17 for the protection of the intake air pressure detection part 12 and the intake air temperature detection part 13 from solutions such as acids, alkalis, etc., is deposited on the entire surface on a concave or recessed side of the sensor module 10 on which the intake air pressure detection part 12 and the intake air temperature detection part 13 are mounted. The organic protective film 17 shown by dotted lines in FIG. 1 serves to protect the intake air pressure detection part 12 and the intake air temperature detection part 13 from the solutions such as acids, alkalis, etc., contained in the air in the intake pipe 4. Paraxylene-based resins are particularly effective in chemical resistance and heat resistant as the organic protective film 17.

Here, note that the thickness of the organic protective film 17 is about several microns, and the thermal capacity thereof is very small, so there is substantially no influence on engine control such as a prolonged delay in the time of temperature measurement, but the protective effect on the intake air pressure detection part 12 and the intake air temperature detection part 13 may be more enhanced by coating a gel on the organic protective film 17 within a range in which the influence is small.

Now, reference will be made to an assembly procedure for the detection apparatus as constructed above.

First of all, the intake air pressure detection part 12 is mounted on the lead frame 11 of the sensor module 10 by using the die bonding resin 14, and at the same time, the intake air temperature detection part 13 is mounted on the lead frame 11 by using the resin paste 16. Thereafter, the intake air pressure detection part 12 and the lead frame 11 are electrically connected to each other by using the gold wire 15.

Subsequently, the organic protective film 17 is deposited on the entire surface at the concave or recessed side of the sensor module 10, and the other end of the terminal 9 is then electrically connected to the lead frame 11 by means of welding. Thereafter, the sensor module 10 and the terminal 9 thus integrated with each other are further integrated with the exterior resin 7 by means of the insert molding.

Thereafter, the basal end portion of the base 1 is connected and fixedly attached to the exterior resin 7 and the sensor module 10 by using the bonding material 6, and a lower end portion of the exterior resin 7 enclosing an intermediate portion of the base 1 is bent while being heated.

Finally, the 0 ring 3 is fitted into the groove 2 in the base 1, and the assembly of the detection apparatus is completed.

In the detection apparatus of the above-mentioned construction, the air in the intake pipe 4 is introduced through the vent hole 18 in the base 1 into a chamber 19 which is defined by the base 1 and the sensor module 10. As a result, in the intake air temperature detection part 13, the resistance value thereof changes in accordance with the temperature of the air thus introduced into the chamber 19, and this change in the resistance value is converted into a corresponding electric signal, which is then output from the terminal 9 to the unillustrated engine control unit through the lead frame 11.

Also, in the intake air pressure detection part 12, a main body thereof is deformed under stress in accordance with the pressure of the air in the chamber 19 thereby to cause the resistance value thereof to change, and this change is converted into a corresponding electric signal, which is then output from the terminal 9 to the engine control unit through the lead frame 11.

As described in the foregoing, according to the detection apparatus of this first embodiment, the intake air temperature detection part 13 and the intake air pressure detection part 12, which generates an amount of own heat proportional to an amount of current consumed by the electronic circuit, are individually formed separately from each other, so the intake air temperature detection part 13 is less prone to receive the influence of the heat from the intake air pressure detection part 12, whereby the accuracy in the measurement of the temperature of air in the intake pipe 4 can be improved. In addition, since the thermistor, which generates substantially no own heat, is used as the intake air temperature detection part 13, the accuracy in the measurement of the intake air temperature detection part 13 can be further improved.

Further, the intake air pressure detection part 12 and the intake air temperature detection part 13 are mounted on the same surface of the lead frame 11, so the simultaneous mounting of these parts becomes possible, thereby making it possible to improve assembling efficiency.

In addition, the chip thermistor for surface mounting is used as the intake air temperature detection part 13, so the automation of assembly thereof becomes possible, thereby making it possible to improve assembling efficiency.

Also, the intake air temperature detection part 13 is attached to the lead frame 11 by using the electrically conductive resin-based paste 16, so in comparison with the case where the intake air temperature detection part 13 is attached to the lead frame 11 by the use of a solder that is generally lower in thermal conductivity than the resin paste 16, heat from the intake air temperature detection part 13, which receives the heat of the air in the chamber 19, becomes less prone to be radiated through the lead frame 11, and hence the air temperature can be detected with accordingly improved accuracy.

Moreover, since the organic protective film 17 is deposited on the entire surface on the concave or recessed side of the sensor module 10 where the intake air pressure detection part 12 and the intake air temperature detection part 13 are mounted, the intake air pressure detection part 12 and the intake air temperature detection part 13 can be protected from the solutions such as acids, alkalis, etc., contained in the air in the intake pipe 4, whereby the reliability of the intake air pressure detection part 12 and the intake air temperature detection part 13 can be improved.

Further, the intake air pressure detection part 12 and the intake air temperature detection part 13 are covered with the organic protective film 17, so such parts as a cover or the like, which are conventionally required for preventing the gel covering the intake air temperature detection part 13 from leaking to the outside, are made unnecessary, whereby the structure of the detection apparatus can be simplified, and the assembling efficiency thereof can be improved.

In addition, according to this first embodiment, upon insertion of the base 1 into the air introduction opening 5, the base 1 is inserted into the air introduction opening 5 with the tip end surface of the base 1 being positioned at a location diametrally outwardly of the inner wall surface of the intake pipe 4, so a stable amount of air is supplied to the inside of the engine with the flow of the air being not obstructed by the detection apparatus.

Further, the intake air temperature detection part 13 detects the temperature of the air that is introduced from the intake pipe 4 into the chamber 19 through the vent hole 18 and is staying there for a moment, so the fluctuation of the temperature detected by the intake air temperature detection part 13 can be suppressed as compared with a conventional intake air temperature detection part which is exposed to the air flowing in the intake pipe 4, whereby the amount of injection fuel in the engine can be controlled in a stable manner.

### Embodiment 2

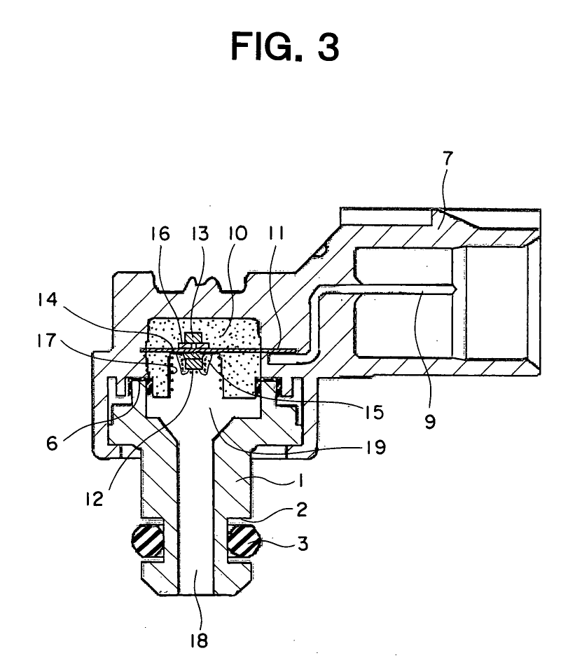

FIG. 3 is a cross sectional view that shows a detection apparatus according to a second embodiment of the present invention.

In this detection apparatus, an intake air pressure detection part 12 is arranged on a surface of a lead frame 11 near the base 1 in an overlapped manner, and an intake air temperature detection part 13 is arranged on a surface of the lead frame 11 remote from the base 1 in an overlapped manner. The intake air temperature detection part 13 is embedded in a sensor module 10.

The construction of this second embodiment other than the above is similar to that of the first embodiment.

In the detection apparatus according to this second embodiment, first of all, the intake air temperature detection part 13 is connected at its electrodes to the lead frame 11 by using a resin paste 16, and thereafter, the sensor module 10 is formed by a transfer molding method. Then, the intake air pressure detection part 12 is mounted on the lead frame 11 of the sensor module 10 by using a die bonding resin 14. Thereafter, the intake air pressure detection part 12 and the lead frame 11 are electrically connected to each other by using a gold wire 15.

Subsequently, an organic protective film 17 is deposited on the entire surface at the concave or recessed side of the sensor module 10, so that the entire surface of the intake air pressure detection part 12 is covered with the organic protective film 17.

The subsequent assembly procedure of the detection apparatus according to this second embodiment is identical to that of the detection apparatus of the first embodiment.

According to the detection apparatus of the second embodiment of the present invention, the intake air temperature detection part 13 and the intake air pressure detection part 12 are mounted on the mutually different surfaces of the lead frame 11 with the intake air temperature detection part 13 being embedded in the sensor module 10. Thus, the detection apparatus can be reduced in size.

In addition, the intake air temperature detection part 13 is covered with an epoxy resin, so there is no need for the organic protective film 17 to protect the intake air temperature detection part 13 from solutions such as acids, alkalis or the like.

### Embodiment 3

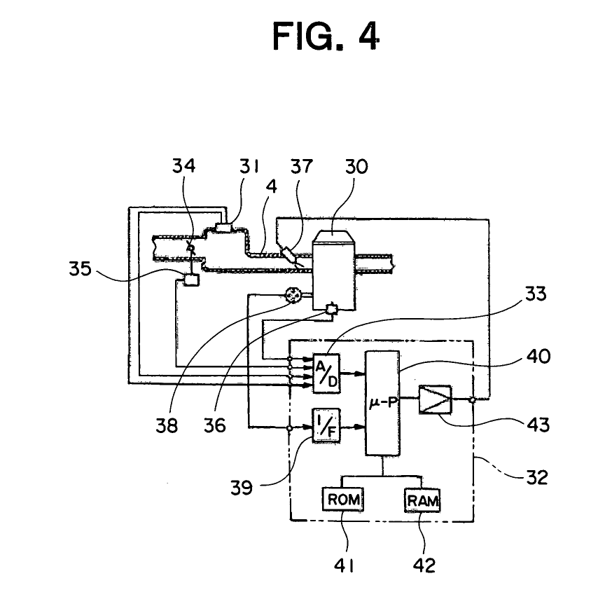

FIG. 4 is a block diagram that shows an engine control unit using the detection apparatus according to the first embodiment of the present invention.

In this block diagram, a detection apparatus 31 constructed according to the first embodiment is installed on an intake pipe 4 that is connected to an engine 30. That is, as shown in FIG. 2, upon insertion of a base 1 into an air introduction opening 5, the base 1 is inserted into the air introduction opening 5 with a tip end surface of the base 1 being positioned at a location diametrally outwardly from the inner wall surface of the intake pipe 4.

A throttle valve 34 is arranged in the intake pipe 4, and an injector 37, to which fuel with its pressure being adjusted to a fixed level is fed under pressure, is installed on the intake pipe 4 in the vicinity of an intake port of each cylinder.

In this engine control unit, electric signals output from the intake air pressure detection part 12 and the intake air temperature detection part 13 to the outside through a terminal 9 of the detection apparatus 31 is input to an A/D converter 33 of a control section 32. Also, opening information on the throttle valve 34 from a throttle sensor 35 and warm-up state information on the engine 30 from a cooling water temperature sensor 36 are input to the A/D converter 33.

In addition, an electric signal from a rotation sensor 38, which detects the rotation of the engine 30 as pulses, is input to an input circuit 39 of the control section 32.

In the control section 32, the A/D converter 33 converts analog signals from the intake air pressure detection part 12, the intake air temperature detection part 13, the throttle sensor 35 and the cooling water temperature sensor 36 of the detection apparatus 31 into corresponding digital values, which are then sent as outputs to a microprocessor 40.

The input circuit 39 converts the level of the pulse input signal from the rotation sensor 38, and sends the thus converted output to the microprocessor 40. The microprocessor 40 calculates an amount of fuel to be supplied to the engine 30 based on the digital signals and the pulse signal obtained from the A/D converter 33 and the input circuit 39, respectively, and outputs a drive pulse of a pulse width corresponding to the calculation result for each injector 37.

The control procedure and data of the microprocessor 40 are stored in a ROM 41 beforehand, and a RAM 42 temporarily stores data in the process of calculation. An output circuit 43 drives each injector 37 in accordance with the output of the microprocessor 40.

In this third embodiment, the detection apparatus 31 is installed on the intake pipe 4 in such a manner that one end portion thereof does not protrude into the interior of the intake pipe 4. In addition, the detection apparatus 31 has the intake air pressure detection part 12 and the intake air temperature detection part 13 which are formed separately from each other, and the engine control unit controls the amount of fuel to be injected into the engine 30 based on the pressure and the temperature detected by the detection apparatus 31. With such an arrangement, the amount of injection fuel can be controlled with high accuracy, thus providing excellent effects in the fuel mileage improvement and the reduction of emissions of air pollutants.

In the case of an engine control unit using the detection apparatus of the above-mentioned second embodiment, too, control on the amount of injection fuel with high accuracy of course becomes possible, as a result of which excellent effects can also be obtained in the fuel mileage improvement and the reduction of emissions of air pollutants.

While the invention has been described in terms of preferred embodiments, those skilled in the art will recognize that the invention can be practiced with modifications within the spirit and scope of the appended claims.

What is claimed is:

1. A detection apparatus which is installed at an air introduction opening formed in an intake pipe, said apparatus comprising:
an exterior resin that is integrated with a terminal having one end portion thereof exposed therefrom;
a sensor module that is received in the inside of said exterior resin and has a lead frame connected to the other end of said terminal;
an intake air pressure detection part that is electrically connected to said lead frame for detecting the pressure of air in said intake pipe;
an intake air temperature detection part that is electrically connected to said lead frame for detecting the temperature of the air in said intake pipe; and
a base that has a base end connected to said exterior resin and at the same time has a vent hole for introducing the air in said intake pipe to said intake air pressure detection part and said intake air temperature detection part;
wherein said intake air pressure detection part and said intake air temperature detection part are formed separately from each other.

2. A detection apparatus which is installed at an air introduction opening formed in an intake pipe, said apparatus comprising:
an exterior resin that is integrated with a terminal having one end portion thereof exposed therefrom;
a sensor module that is received in the inside of said exterior resin and has a lead frame connected to the other end of said terminal;
an intake air pressure detection part that is electrically connected to said lead frame for detecting the pressure of air in said intake pipe;
an intake air temperature detection part that is electrically connected to said lead frame for detecting the temperature of the air in said intake pipe; and
a base that has a base end connected to said exterior resin and at the same time has a vent hole for introducing the air in said intake pipe to said intake air pressure detection part and said intake air temperature detection part;
wherein upon insertion of said base into said air introduction opening, said base is inserted into said air introduction opening with a tip end surface of said base being positioned on an inner wall surface of said intake pipe or at a location diametrally outwardly therefrom.

3. The detection apparatus as set forth in claim 1, wherein upon insertion of said base into said air introduction opening, said base is inserted into said air introduction opening with a tip end surface of said base being positioned on an inner wall surface of said intake pipe or at a location diametrally outwardly therefrom.

4. The detection apparatus as set forth in claim 1, wherein said intake air pressure detection part and said intake air temperature detection part are respectively arranged on the same surface of said lead frame.

5. The detection apparatus as set forth in claim 1, wherein said intake air pressure detection part is arranged on a surface of said lead frame near said base, and said intake air temperature detection part is arranged on a surface of said lead frame remote from said base.

6. The detection apparatus as set forth in claim 1, wherein said intake air temperature detection part is fixedly secured to said lead frame by using an electrically conductive resin paste.

7. The detection apparatus as set forth in claim 1, wherein said intake air temperature detection part comprises a chip thermistor for surface mounting.

8. The detection apparatus as set forth in claim 1, wherein an organic protective film is formed on surfaces of said intake air pressure detection part and said intake air temperature detection part.

9. An engine control unit in which an amount of fuel to be injected into an engine including the pressure and the temperature of said air detected by using said detection apparatus as set forth in claim 1 is controlled.
